(19) United States
(12) Patent Application Publication
(10) Pub. No.: US 2007/0280267 A1
(43) Pub. Date: Dec. 6, 2007

(54) Completely Dry Pseudowires

(75) Inventor: Hamid Ould-Brahim, Kanata (CA)

Correspondence Address: McGUINNESS & MANARAS LLP, 125 NAGOG PARK, ACTON, MA, 01720, US

(73) Assignee: Nortel Networks Limited

(21) Appl. No.: 11/679,897

(22) Filed: Feb. 28, 2007

Related U.S. Application Data
(60) Provisional application No. 60/779,212, filed on Mar. 3, 2006.

(51) Int. Cl. H04L 12/56

(52) U.S. Cl. 370/395.53; 370/395.1

(57) ABSTRACT

Techniques are described for implementing completely dry pseudowires which can be utilized for transporting protocol data units formatted in accordance with a first protocol from a first device to a second device. In response to receipt of a first protocol data unit from the first device, a first switch encapsulates that first protocol data unit in a pseudowire payload of a second protocol data unit. The first switch then configures at least one service demultiplexing field of the second protocol data unit to indicate that the second protocol data unit is associated with a pseudowire. The first switch then transmits the second protocol data unit to a second switch via a second protocol tunnel. The second switch unencapsulates the first protocol data unit and transmits the first protocol data unit to the second device based at least in-part upon recognition of the at least one service demultiplexing field of the second protocol data unit. Advantageously, completely dry pseudowires do not require an “MPLS service label” or an IP demultiplexing scheme such as 12tpv3 session ID, and can be transmitted across a non-MPLS/IP transport network, such as Ethernet.

### CROSS-REFERENCE TO RELATED APPLICATIONS

A claim of priority is made to U.S. Provisional Patent Application Ser. NO. 60/779,212, entitled COMPLETELY DRY PSEUDOWIRES, filed Mar. 3, 2006, which is incorporated by reference.

### FIELD OF THE INVENTION

This invention is generally related to the field of network communications, and more particularly to pseudowires which utilize the service demultiplexing capability of a native Layer 2 protocol to indicate a network exit point for an encapsulated packet.

### BACKGROUND OF THE INVENTION

The term “pseudowire” refers to a technique for emulating Layer 2 services over a Layer 3 packet-switched network. Pseudowires are typically used by network operators to provide legacy services across Internet Protocol (“IP”) network segments, Layer 2 Tunneling Protocol (“L2TP”) network segments, and Multi-Protocol Label Switching (“MPLS”) network segments. The legacy services are often associated with equipment based on a well established and widely deployed protocol such as Asynchronous Transfer Mode (“ATM”), Frame Relay or Ethernet, with which subscribers are familiar and comfortable. Pseudowires are useful to network operators because the present trend among network operators is to install equipment that supports IP/MPLS rather than legacy protocols, particularly when adding or replacing network backbone resources.

In an exemplary MPLS pseudowire implementation, two unidirectional, inner-tunnel, label-switched paths (“LSPs”) are established in unidirectional, outer-tunnel LSPs which act as traffic-engineering tunnels and create a bidirectional connection between provider edge (“PE”) routers. The inner LSPs form the pseudowire by using an interworking function (“IWF”) that encapsulates customer edge (“CE”) transmissions in formats such as Frame Relay, ATM, and Ethernet into the IETF PWE3 format. At the exit point of the pseudowire, the transmissions are unencapsulated and delivered to the destination CE device. A pseudowire indicator is appended to the encapsulated packet to prevent the pseudowire packet from being processed as an ordinary IP/MPLS packet. In particular, a pseudowire label, a.k.a., a “service label,” is written into an inner label of the MPLS label stack. This technique is used for both MPLS-in-IP tunnel and an MPLS-in-GRE tunnel implementations as the pseudowire demultplexing scheme.

### SUMMARY OF THE INVENTION

In accordance with one embodiment of the invention, apparatus for transporting protocol data units formatted in accordance with a first protocol from a first device to a second device comprises: a first switch configured to support a second protocol, the second protocol defining at least one service demultiplexing field; and a second switch configured to support the second protocol; wherein the first and second switches are in communication via a second protocol tunnel, and where the first switch is operable in response to receipt of a first protocol data unit from the first device to encapsulate that first protocol data unit in a pseudowire payload of a second protocol data unit, and where the first switch is further operable to configure at least one service demultiplexing field of the second protocol data unit to indicate that the second protocol data unit is associated with a pseudowire, the first switch being further operable to transmit the second protocol data unit to the second switch via the second protocol tunnel, and the second switch being operable in response to receipt of the second protocol data unit to unencapsulate the first protocol data unit and then transmit the first protocol data unit to the second device based at least in-part upon recognition of the at least one service demultiplexing field of the second protocol data unit.

In accordance with another embodiment of the invention, a method for transporting protocol data units formatted in accordance with a first protocol from a first device to a second device, comprises the steps of: with a first switch configured to support a second protocol, the second protocol defining at least one service demultiplexing field, and a second switch configured to support the second protocol, wherein the first and second switches are in communication via a second protocol tunnel, in response to receipt of a first protocol data unit from the first device to the first switch, encapsulating that first protocol data unit in a pseudowire payload of a second protocol data unit; configuring at least one service demultiplexing field of the second protocol data unit to indicate that the second protocol data unit is associated with a pseudowire; transmitting the second protocol data unit from the first switch to the second switch via the second protocol tunnel; unencapsulating the first protocol data unit by the second switch in response to receipt of the second protocol data unit; and transmitting the first protocol data unit to the second device based at least in-part upon recognition of the at least one service demultiplexing field of the second protocol data unit.

Advantageously, completely dry pseudowires do not require an “MPLS service label” or an IP demultiplexing scheme such as 12tpv3 session ID, and can be transmitted across a non-MPLS/IP transport network, such as Ethernet. Further, completely dry pseudowires do not necessarily require an MPLS control plane.

### BRIEF DESCRIPTION OF THE FIGURES

FIG. 1 illustrates a generic Layer 2 protocol packet format adapted for use with completely dry pseudowires.

FIG. 2 illustrates a network with a pseudowire for transporting the packet of FIG. 1.

FIGS. 3 and 4 illustrate an Ethernet packet format adapted to support pseudowires.

FIG. 5 illustrates a network including an Ethernet switched path pseudowire for transporting the packets of FIGS. 3 and 4.

FIG. 6 is a flow diagram illustrating operation of completely dry pseudowires.

### DETAILED DESCRIPTION

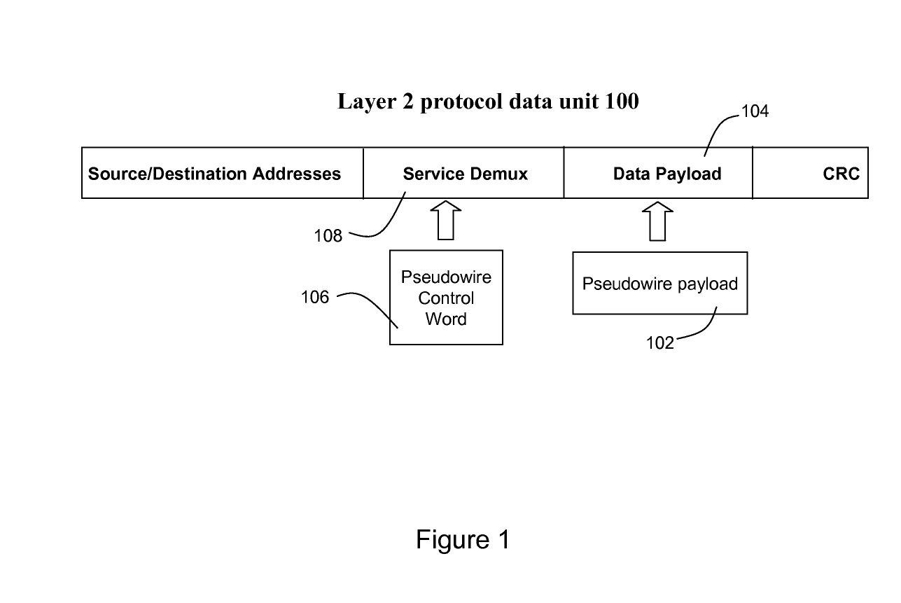

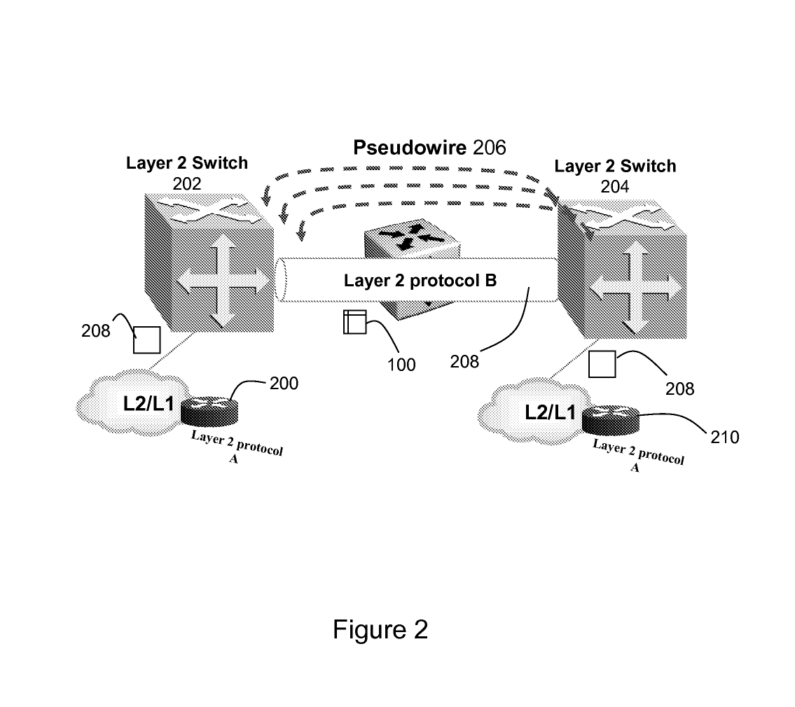

FIGS. 1 and 2 illustrate a generic network and protocol data unit (100) format for implementing a completely dry pseudowire. Unlike previous pseudowire implementations, the illustrated implementation is not limited to use with a particular protocol. The network includes a Customer Edge device (200) which utilizes a first Data Link Layer (“Layer 2”) protocol, shown as “protocol A.” Examples of protocols which could be used as protocol A include, but are not limited to, Frame Relay, Ethernet, Time Division Multiplexing (“TDM”) and Asynchronous Transfer Mode (“ATM”). A service provider backbone portion of the network includes Layer 2 switches (202, 204) which utilize Layer 2 protocol B, which may also be Frame Relay, Ethernet, TDM, or ATM, but is not the same as protocol A. It should be noted that the terms “switch” and “router” are used interchangeably in this document, and are not intended to convey any particular distinction.

The service provider backbone portion of the network implements the pseudowire (206). The customer edge device (200) is operative to transmit protocol data units (208), which are formatted according to Layer 2 protocol A, to the logically adjacent Layer 2 switch (202) of the service provider network. The Layer 2 switch (202) is operative in response to receipt of a protocol A protocol data unit (208) from the customer edge device (200) to encapsulate that protocol data unit (208) and thereby generate a protocol data unit (100) formatted in accordance with Layer 2 protocol B. In particular, the protocol A data unit (208) is inserted as a pseudowire payload (102) into the data payload field (104) of the protocol B data unit (100). A pseudowire control word (106) is then inserted into a native service demux field or fields (108) of the protocol B data unit (100) in order to identify the protocol B data unit as being associated with the pseudowire (206), i.e., not native to protocol B. The control word (106) also indicates a network exit point, e.g. a port on Layer 2 switch (204). Fields in the pseudowire control word (106) may, but need not necessarily, include flags for per-payload signaling, a non-fragmenting payload indicator, a length field, and sequence number. The resulting adapted protocol data unit (100) is then transmitted across the backbone to Layer 2 protocol B switch (204) via a protocol B tunnel (208). The receiving Layer 2 switch (204) is operable to inspect the pseudowire protocol data unit (100) upon receipt. In particular, the switch (204) recognizes the protocol data unit (100) as an encapsulated pseudowire protocol data unit from the pseudowire control word (106). If the control word indicates a network exit point associated with a port of the receiving Layer 2 switch (204), the switch (204) is operative to unencapsulate the protocol data unit (100) by removing the pseudowire payload (102), thereby recreating the Layer 2 protocol A data unit (208) that was transmitted by the customer edge device (200). That protocol A data unit (208) can then be transmitted to another protocol A device (210).

A protocol A data unit transmitted to the customer edge device (200) from Layer 2 protocol A device (210) would also be encapsulated as described above and transmitted across the pseudowire (206). The appropriate exit port for the protocol data unit, i.e., the exit port of Layer 2 switch (202) which connects to the customer edge device (200), would be identified by the pseudowire control word and used to direct the protocol B (pseudowire) data unit to that switch. Following receipt of the pseudowire data unit, the receiving switch is operative to unencapsulate the pseudowire data unit. In particular, the protocol A data unit is copied out of the pseudowire data unit payload, resulting in a native Layer 2 protocol A data unit. The resulting protocol A data unit is then transmitted from the switch to the customer edge device.

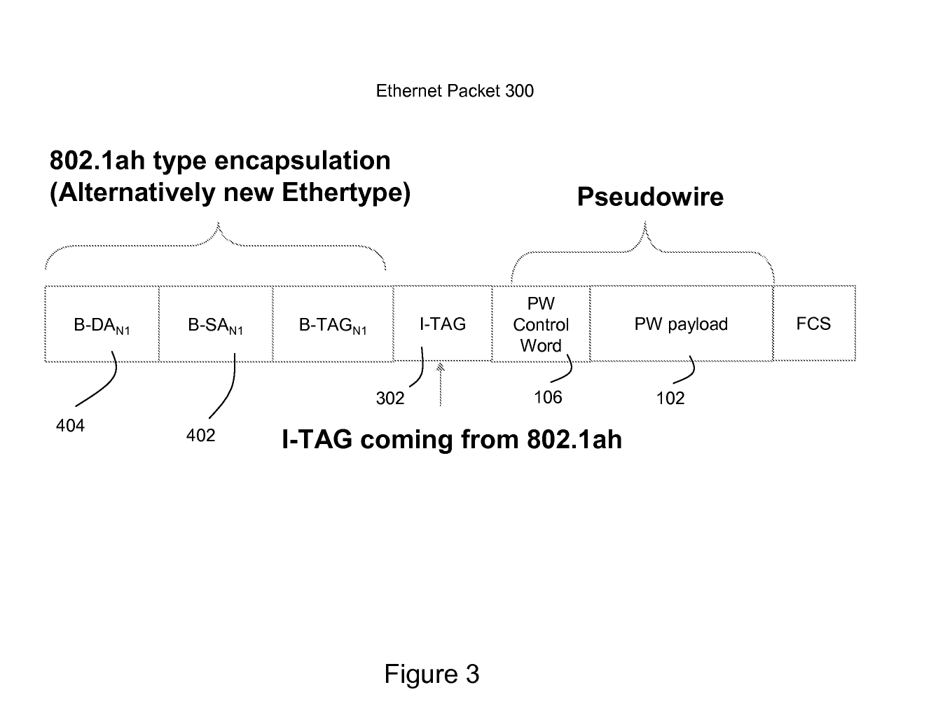

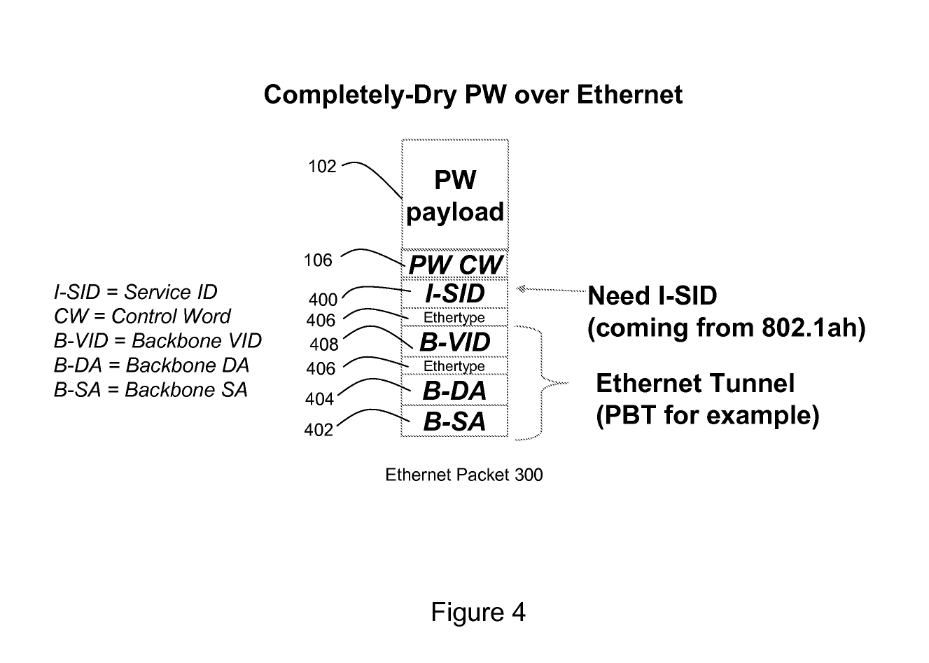

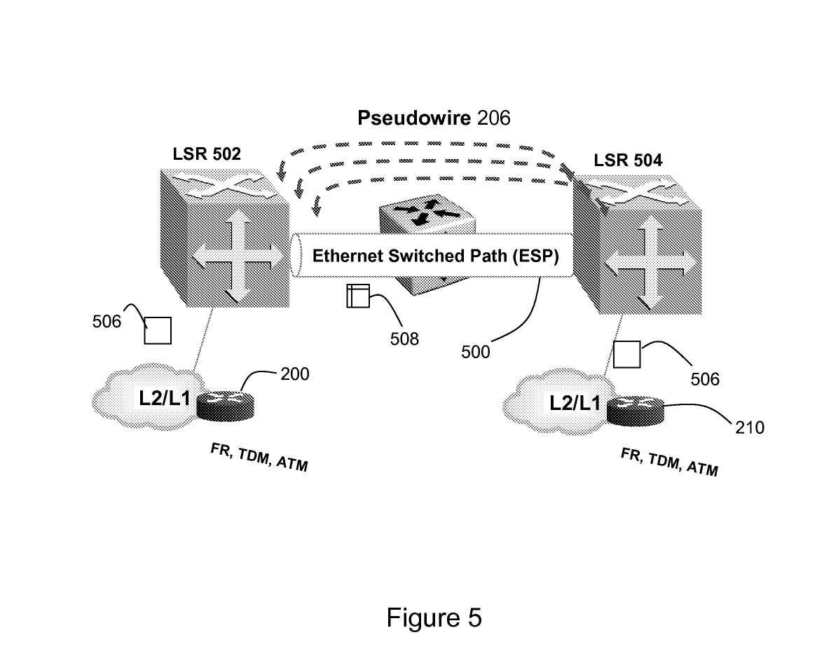

FIGS. 3, 4 and 5 illustrate a specific embodiment of the technique described above. In particular, those figures illustrate use of Ethernet as the Layer 2 protocol B. In this example the customer edge device (200) utilizes Frame Relay, TDM or ATM, and the backbone devices are Label Switched Routers. For simplicity, ATM will be referenced as the Layer 2 protocol A in the following description.

In order to create the pseudowire, an Ethernet switched path tunnel (500) is established between the label switched routers (502, 504). This may, but need not necessarily, be accomplished as described by IEEE 802.1ah. If IEEE 802.1ah is utilized for the pseudowire over Ethernet, then the 802.1ah encapsulation technique can be utilized, but with certain distinctions relative to 802.1ah. One distinction is that the completely dry pseudowire can encapsulate services including Ethernet, ATM, FR, and TDM, rather than only Ethernet customer frames. Another distinction is that when the attachment circuit (customer facing) is Ethernet, then the completely dry pseudowire over Ethernet uses 802.1ah but with a pseudowire control word. Optionally, however, the control word may be omitted as will be discussed below.

In the illustrated example, an incoming ATM cell (506) from the customer edge device (200) is encapsulated by the receiving label switched router (502). In particular, the ATM cell (200) is inserted as a pseudowire payload (102) in an Ethernet packet (300). The Ethernet packet is then adapted for transport on the Ethernet switched path (500) by appending a pseudowire control word (106) to the packet. Additional fields that may be appended to the packet include a service ID (“I-SID”) (400), backbone source address (“B-SA”) (402), backbone destination address (“B-DA”) (404), Ethertype fields (406), and tag fields such as a backbone virtual local area network ID (“B-VID”) (408) and customer VLAN ID (“I-TAG”) (302). It is desirable to generate mappings at edges devices between I-SID and attachment circuit Identifiers (AII). I-SID is a double sided provisioning model and can map to the pseudowire ID. The adapted Ethernet packet is then transported over the Ethernet switched path to the receiving label switched router designated by the B-DA. The receiving label switched router then recreates the original ATM cell from the pseudowire payload of the adapted Ethernet packet. The ATM cell may then be transmitted to another device, such as ATM switch.

In an alternative embodiment, a new Ethertype is employed to indicate that a Dry-Pseudowire is being carried, rather than native Ethernet frames. Further, if the pseudowire is static then there is no need for a control plane. If LDP is used, then the label will encode an I-SID, i.e., the label is only used in the control plane if LDP is used.

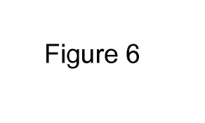

FIG. 6 is a flow diagram that further illustrates an embodiment of the technique. <need drawing and some help with description>

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. Apparatus for transporting protocol data units formatted in accordance with a first protocol from a first device to a second device comprising:
a first switch configured to support a second protocol, the second protocol defining at least one service demultiplexing field; and
a second switch configured to support the second protocol;
wherein the first and second switches are in communication via a second protocol tunnel, and where the first switch is operable in response to receipt of a first protocol data unit from the first device to encapsulate that first protocol data unit in a pseudowire payload of a second protocol data unit, and where the first switch is further operable to configure at least one service demultiplexing field of the second protocol data unit to indicate that the second protocol data unit is associated with a pseudowire, the first switch being further operable to transmit the second protocol data unit to the second switch via the second protocol tunnel, and the second switch being operable in response to receipt of the second protocol data unit to unencapsulate the first protocol data unit and then transmit the first protocol data unit to the second device based at least in-part upon recognition of the at least one service demultiplexing field of the second protocol data unit.

2. The apparatus of claim 1 wherein the first protocol is selected from the group is selected from the group consisting of Frame Relay, Ethernet, Time Division Multiplexing (“TDM”), and Asynchronous Transfer Mode (“ATM”).

3. The apparatus of claim 2 wherein the second protocol is selected from the group consisting of Frame Relay, Ethernet, TDM, and ATM, and the first protocol is different than the second protocol.

4. The apparatus of claim 1 wherein the service demultiplexing field includes a pseudowire control word.

5. The apparatus of claim 4 wherein the pseudowire control word includes an indication of a network exit point.

6. The apparatus of claim 5 wherein the pseudowire control word includes at least one of flags for per-payload signaling, a non-fragmenting payload indicator, a length field, and sequence number.

7. The apparatus of claim 1 wherein the first protocol switch is further operable to configure the second protocol data unit with at least one of a service ID (“I-SID”), backbone source address (“B-SA”), backbone destination address (“B-DA”), Ethertype fields, and tag fields such as a backbone virtual local area network ID (“B-VID”) and customer VLAN ID (“I-TAG”).

8. The apparatus of claim 1 wherein an Ethertype is employed to indicate that the second protocol data unit is associated with the pseudowire.

9. A method for transporting protocol data units formatted in accordance with a first protocol from a first device to a second device, comprising the steps of:
with a first switch configured to support a second protocol, the second protocol defining at least one service demultiplexing field, and a second switch configured to support the second protocol, wherein the first and second switches are in communication via a second protocol tunnel,
in response to receipt of a first protocol data unit from the first device to the first switch, encapsulating that first protocol data unit in a pseudowire payload of a second protocol data unit;
configuring at least one service demultiplexing field of the second protocol data unit to indicate that the second protocol data unit is associated with a pseudowire;
transmitting the second protocol data unit from the first switch to the second switch via the second protocol tunnel;
unencapsulating the first protocol data unit by the second switch in response to receipt of the second protocol data unit; and
transmitting the first protocol data unit to the second device based at least in-part upon recognition of the at least one service demultiplexing field of the second protocol data unit.

10. The method of claim 9 wherein the first protocol is selected from the group is selected from the group consisting of Frame Relay, Ethernet, Time Division Multiplexing (“TDM”), and Asynchronous Transfer Mode (“ATM”).

11. The method of claim 10 wherein the second protocol is selected from the group consisting of Frame Relay, Ethernet, TDM, and ATM, and the first protocol is different than the second protocol.

12. The method of claim 9 wherein the service demultiplexing field includes a pseudowire control word.

13. The method of claim 12 wherein the pseudowire control word includes an indication of a network exit point.

14. The method of claim 13 wherein the pseudowire control word includes at least one of flags for per-payload signaling, a non-fragmenting payload indicator, a length field, and sequence number.

15. The method of claim 9 including the further step of the first protocol switch configuring the second protocol data unit with at least one of a service ID (“I-SID”), backbone source address (“B-SA”), backbone destination address (“B-DA”), Ethertype fields, and tag fields such as a backbone virtual local area network ID (“B-VID”) and customer VLAN ID (“I-TAG”).

16. The method of claim 9 including the further step of employing an Ethertype to indicate that the second protocol data unit is associated with the pseudowire.
